(19) United States
(12) Patent Application Publication
(10) Pub. No.: US 2013/0229398 A1
(43) Pub. Date: Sep. 5, 2013

(54) DISPLAY APPARATUS AND METHOD OF DRIVING THE SAME

(71) Applicants: Dae-Yeon Lee, Cheonan-si (KR); Sangwon Kim, Seoul (KR); Seungyoung Lee, Hwaseong-si (KR)

(72) Inventors: Dae-Yeon Lee, Cheonan-si (KR); Sangwon Kim, Seoul (KR); Seungyoung Lee, Hwaseong-si (KR)

(21) Appl. No.: 13/532,116

(22) Filed: Jun. 25, 2012

(30) Foreign Application Priority Data
Mar. 2, 2012 (KR) 10-2012-0021964

(51) Int. Cl. G09G 3/36; G09G 5/00

(52) U.S. Cl. 345/209; 345/96

(57) ABSTRACT

A display apparatus includes a signal controller, a data driver, a display part, and a gate driver. The signal controller receives an image signal in accordance with a data transmission mode, receives a mode selection signal indicating the data transmission mode, and outputs one of a first inversion signal and a second inversion signal based on the indicated type. The data driver converts the image signal from the signal controller to data signals and controls a polarity of the data signals based on the output inversion signal. The display part includes a plurality of pixels to display an image. The signal controller is further configured to control the gate driver to sequentially output a plurality of gate signals to operate the pixels to receive the data signals.

### CROSS-REFERENCE TO RELATED APPLICATION

This application claims priority under 35 U.S.C. §119 to Korean Patent Application No. 10-2012-0021964, filed on Mar. 2, 2012, the disclosure of which is incorporated by reference herein.

1. Technical Field

Embodiments of the invention relate to a display apparatus and a method of driving the same.

2. Discussion of Related Art

A timing controller of a display apparatus may receive an image signal from an external device. The external device can transmit the image signal to the timing controller in a progressive mode or in an interlace mode.

In the progressive mode, the external device transmits the image signal corresponding to one image frame at a time to the timing controller. In the interlace mode, the external device transmits data corresponding to even-numbered rows of the one frame to the timing controller after transmitting data corresponding to odd-numbered rows of the one frame to the timing controller.

However, when data is transmitted in the interlace mode, flickering occurs between images displayed using the data of the odd-numbered rows and images displayed using the data of the even-numbered rows. Further, when the modes are switched, a linear after-image appears at a boundary between areas with gray scale differences due to the flickering.

### SUMMARY

Embodiments of the present disclosure provide a display apparatus that is capable of removing an after-image to improve a display quality and a method of driving the display apparatus.

A display apparatus according to an exemplary embodiment of the inventive concept includes a signal controller, a data driver, a gate driver, and a display part. The signal controller receives an image signal in accordance with a data transmission mode, receives a mode selection signal indicating the data transmission mode, and outputs one of a first inversion signal and a second inversion signal based on the indicated data transmission mode. The data driver converts the image signal from the signal controller to data signals and controls a polarity of the data signals based on the output inversion signal from the signal controller. The display part includes a plurality of pixels to display an image. The signal controller is further configured to control the gate driver to sequentially output a plurality of gate signals to operate the pixels to receive the data signals.

A method of driving a display apparatus according to an exemplary embodiments of the inventive concept includes receiving an image signal in accordance with a data transmission mode, receiving a mode selection signal indicating the data transmission mode to selectively output one of a first inversion signal and a second inversion signal based on the indicated data transmission mode, converting the image signal to data signals, receiving the output inversion signals to control a polarity of the data signals, outputting a plurality of gate signals, and sequentially operating pixel rows of pixels of the display apparatus in response to the gate signals to display an image corresponding to the data signals.

In at least one embodiment, the signal controller controls the polarity of the data signals in accordance with the data transmission mode, and thus the polarity of the data signals are inverted every two or more frame periods in the interlace mode.

A display apparatus according to an exemplary embodiment of the invention includes a signal controller, a data driver, a gate driver, and a display. The signal controller is configured to receive an image signal and mode selection signal indicating a transmission mode, output a first inversion signal when the mode is progressive and a second inversion signal when the mode is interlace. The data driver is configured to generate data signals from the image signal and control a polarity of the data signals based on the output inversion signal. The gate driver is configured to generate gate signals. The display is configured to receive the data signals and the gate signals to display an image. The first inversion signal is inverted each time one of the gate signals is applied during a given image frame period, and the second inversion signal is inverted each time 2n of the gate signals is applied during the given image period, where n is greater than or equal to 1.

### BRIEF DESCRIPTION OF THE DRAWINGS

Exemplary embodiments of the present invention will become readily apparent by reference to the following detailed description when considered in conjunction with the accompanying drawings wherein:

FIG. 1 is a block diagram showing a display apparatus according to an exemplary embodiment of the invention;

FIG. 2A is a view showing a sequential mode of a data transmission mode;

FIG. 2B is a view showing an interlaced mode of a data transmission mode;

FIG. 3 is a waveform diagram showing first and second inversion signals shown in FIG. 1;

FIG. 4 is a plan view showing a screen of a display panel in which a black pattern and a white pattern are repeatedly displayed;

FIG. 5A is a view showing a data voltage of an area A1 of FIG. 4 in an example of a 1-frame inversion driving scheme;

FIG. 5B is a view showing a data voltage of an area A1 of FIG. 4 in an example of a 2-frame inversion driving scheme;

FIG. 6A is a waveform diagram showing a variation of a data voltage shown in FIG. 5A;

FIG. 6B is a waveform diagram showing a variation of a data voltage shown in FIG. 5B;

FIG. 7 is a cross-sectional view showing a display apparatus according to an exemplary embodiment of the invention;

FIG. 8 is a waveform diagram showing first and second inversion signals according to an exemplary embodiment of the present invention;

FIG. 9 is a plan view showing the display apparatus shown in FIG. 1;

FIG. 10 is a block diagram showing a display apparatus according to an exemplary embodiment of the invention; and

FIG. 11 is a plan view showing the display apparatus shown in FIG. 10.

### DETAILED DESCRIPTION

It will be understood that when an element or layer is referred to as being “on”, “connected to” or “coupled to” another element or layer, it can be directly on, connected or coupled to the other element or layer or intervening elements or layers may be present.

As used herein, the singular forms, “a”, “an” and “the” are intended to include the plural forms as well, unless the context clearly indicates otherwise.

Hereinafter, exemplary embodiments of the present invention will be explained in detail with reference to the accompanying drawings.

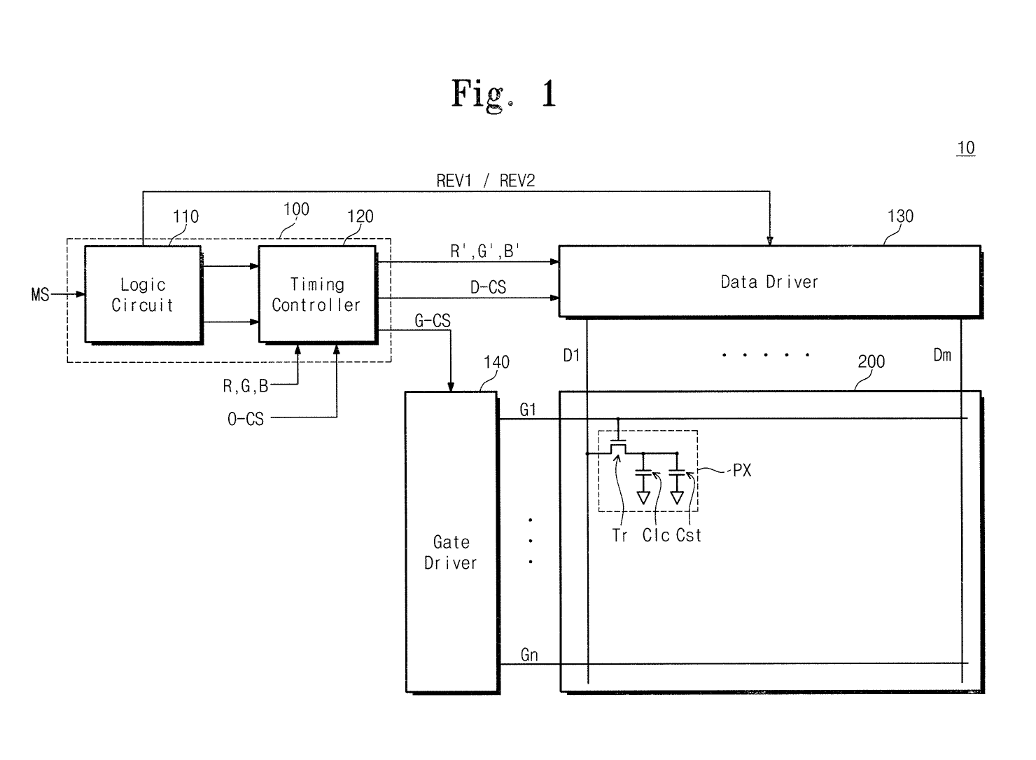

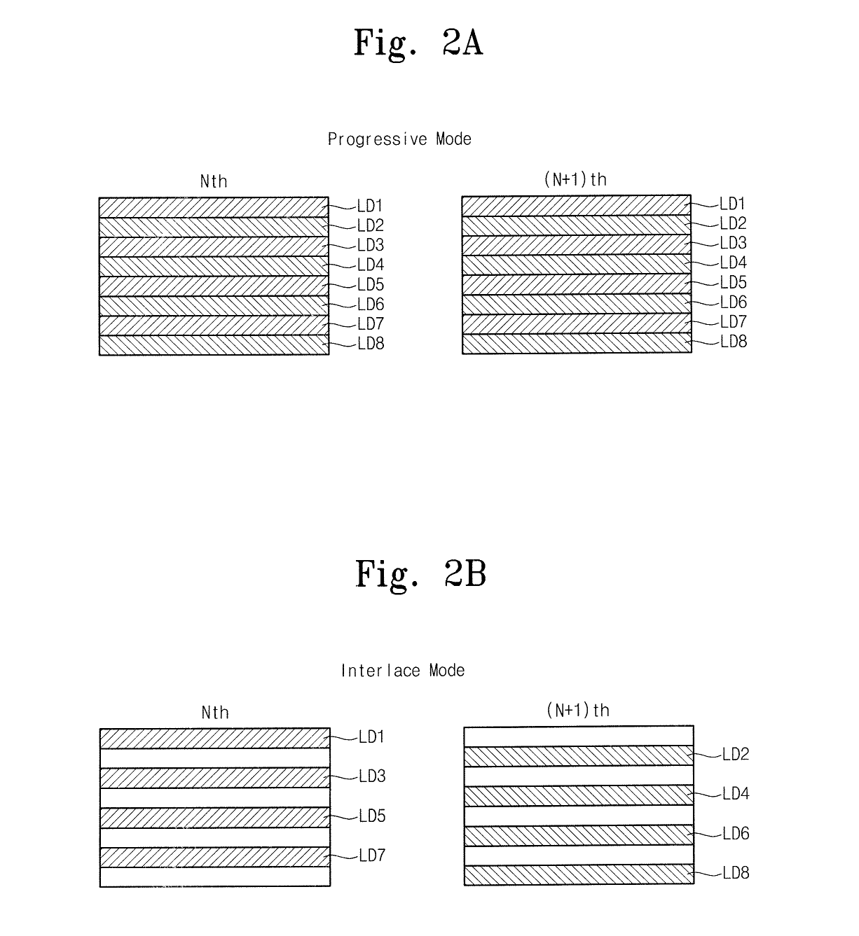

FIG. 1 is a block diagram showing a display apparatus according to an exemplary embodiment of the invention. FIG. 2A is a view showing a sequential mode of a data transmission mode, and FIG. 2B is a view showing an interlaced mode of a data transmission mode.

Referring to FIG. 1, a display apparatus 10 includes a signal controller 100, a data driver 130, a gate driver 140, and a display panel 200.

The display panel 200 includes a plurality of data lines D1 to Dm, a plurality of gate lines G1 to Gn, and a plurality of pixels PX. The gate lines G1 to Gn may be insulated from the data lines D1 to Dm while crossing the data lines D1 to Dm.

For the convenience of explanation, only one pixel among the pixels PX has been shown in FIG. 1. Each of the pixels PX is electrically connected to a corresponding gate line of the gate lines G1 to Gn and a corresponding data line of the data lines D1 to Dm. For example, the pixel shown in FIG. 1 is electrically connected to a first gate line G1 and a first data line D1. In addition, each of the pixels PX includes a thin film transistor Tr, a liquid crystal capacitor Clc, and a storage capacitor Cst.

The thin film transistor Tr includes a gate electrode electrically connected to the first gate line G1, a source electrode electrically connected to the first data line D1, and a drain electrode electrically connected to the liquid crystal capacitor Clc and the storage capacitor Cst.

The liquid crystal capacitor Clc includes a pixel electrode (not shown) electrically connected to the drain electrode of the thin film transistor Tr, a common electrode (not shown) facing the pixel electrode, and liquid crystals (not shown) whose orientations are altered by an electric field formed between the pixel electrode and the common electrode. The storage capacitor Cst includes a first electrode (not shown) electrically connected to the drain electrode of the thin film transistor Tr, a second electrode (not shown) facing the first electrode, and an insulating layer (not shown) interposed between the first and second electrodes.

The signal controller 100 includes a logic circuit 110 and a timing controller 120. The timing controller 120 receives image signals R, G, and B and control signals O-CS, such as a horizontal synchronization signal, a vertical synchronization signal, a clock signal, and a data enable signal, etc. The image signals and the controls signals may be sent from a source external to the display apparatus 10. In an alternate embodiment, the image signals are not color image signals, but black and white image signals.

The timing controller 120 converts a data format of the image signals R, G, and B into another data format corresponding to an interface between the data driver 130 and the timing controller 120 and provides the converted image signals R′, G′, and B′ to the data driver 130. In addition, the timing controller 120 generates a data control signal D-CS, such as an output start signal, a horizontal start signal, a horizontal clock signal, etc., and a gate control signal G-CS, such as a vertical start signal, a vertical clock signal, a vertical clock bar signal, etc., based on the control signals O-CS. The data control signal D-CS is applied to the data driver 130 and the gate control signal G-CS is applied to the gate driver 140.

The timing controller 120 is configured to receive the image signals R, G, and B in various data transmission modes. For example, the data transmission modes may include a progressive mode (e.g., non-interlaced) and an interlace mode.

Referring to FIGS. 2A and 2B, the timing controller 120 sequentially receives data (e.g., LD1 to LD8) corresponding to one frame in the progressive mode. In the present exemplary embodiment, each of the data LD1 to LD8 corresponds to a different row of the frame.

In the interlace mode, the timing controller 120 receives the data corresponding to odd-numbered rows LD1, LD3, LD5, and LD7 (hereinafter, referred to as odd-numbered row data) during a first frame period Nth and then receives the data corresponding to even-numbered rows LD2, LD4, LD6, and LD8 (hereinafter, referred to as even numbered row data) during a second frame period (N+1)th.

In an embodiment, the data transmission mode depends on an external device (not shown) connected to the display apparatus 10. Accordingly, the timing controller 120 receives the image signals R, G, and B in the progressive mode or the interlace mode according to the data transmission mode sent by the external device.

Referring to FIG. 1, the logic circuit 110 receives a mode selection signal MS containing information about the data transmission mode and selectively outputs either a first inversion signal REV1 or a second inversion signal REV2 in response to the mode selection signal MS. For example, the mode selection signal MS can indicate whether the data transmission mode is the progressive mode or the interlace mode. FIG. 1 shows two separate output lines of the logic circuit 110, where one can be used to transmit the first inversion signal REV1, while the other can be used to transmit the second inversion signal REV2. Thus, the timing controller 120 may include a first pin for receiving the first inversion signal REV1 and a second pin for receiving the second inversion signal REV2. However, in an alternate embodiment, the logic circuit 110 uses a single line to transmit the inversion signals. Thus, the timing controller 120 may include only the first pin for receiving the inversion signals. Additionally, the timing controller 120 may include a pin for receiving the image signals R, G, B, a pin for receiving the control signals O-CS, a pin for outputting the converted image signals R′, G′, B′, a pin for outputting the data control signal D-CS, and a pin for outputting the gate control signal G-CS.

As an example, the mode selection signal MS is in a logic low state in the progressive mode and in a logic high state in the interlace mode. However, in an alternate embodiment, the mode selection signal MS is in the logic high state to indicate the progressive mode and in the logic state low to indicate the interlace mode. The logic circuit 110 outputs the first inversion signal REV1 in the progressive mode and outputs the second inversion signal REV2 in the interlace mode.

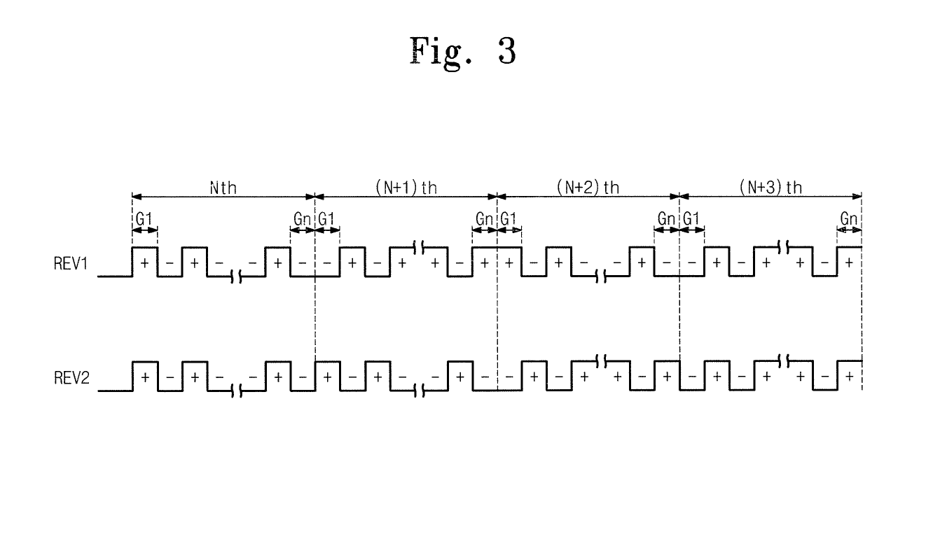

FIG. 3 is a waveform diagram showing examples of first and second inversion signals shown in FIG. 1.

Referring to FIG. 3, the first inversion signal REV1 is phase inverted every frame period and inverted every row (e.g., one gate line) within the one frame period. As an example, the second inversion signal REV2 is phase inverted every two frame periods and inverted every row within the one frame period. The second inversion signal REV2 may be inverted every 2n frame periods (e.g., n is a natural number equal to or larger than 1), as shown in FIG. 3. However, embodiments of the invention are not limited thereto.

When the mode selection signal MS is in the high state, the logic circuit 110 transmits a signal to the timing controller 120 to indicate that the data transmission mode is the interlace mode. In response to the signal from the logic circuit 110, the timing controller 120 causes the logic circuit 110 to output the second inversion signal REV2 and controls an output timing of the second inversion signal REV2.

Referring again to FIG. 1, the gate driver 140 sequentially outputs gate signals that swing or transition between a gate-on voltage and a gate-off voltage in response to the gate control signal G-CS from the timing controller 120. Thus, the display panel 200 may be sequentially scanned by the gate signals.

The data driver 130 selects gray scale voltages respectively corresponding to the image signals R′, G′, and B′ among a plurality of gray scale voltages in response to the data control signal D-CS from the timing controller 120. The data driver 130 outputs the selected gray scale voltages as data voltages. The data voltages are applied to the data lines D1 to Dm of the display panel 200.

Since the timing controller 120 receives the data corresponding to the one frame in the progressive mode, the data driver 140 may apply the data voltages, which correspond to the one frame, to the data lines D1 to Dm of the display panel 200.

In the interlace mode, however, the timing controller 120 receives the odd-numbered row data during the first frame period Nth and then receives the even-numbered row data during the second frame period (N+1)th. The timing controller 120 generates first frame data corresponding to the one frame based on the odd-numbered row data and generates second frame data corresponding to the one frame based on the even-numbered row data.

Thus, the data driver 130 converts the first frame data to first data voltages and the second frame data to second data voltages.

The timing controller 120 may generate the even-numbered row data of the first frame data using the odd-numbered row data. For example, (i+1)th row data may be generated using an i-th row data (i is an odd number equal to or larger than 1) and (i+2)th row data. As an example, the (i+1)th row data may be set to an average value of the i-th row data and the (i+2)th row data.

In addition, the timing controller 120 may generate the odd-numbered row data of the second frame data using the even-numbered row data. For example, (j+1)th row data may be generated using j-th row data (j is an even number equal to or larger than 2) and (j+2)th row data. As an example, the (j+1)th row data may be set to an average value of the j-th row data and the (j+2)th row data.

Accordingly, the data voltages generated by the data driver 130 may include real odd-numbered data voltages and virtual even-numbered data voltages obtained by converting the even-numbered row data generated by the calculation mentioned above. In addition, the second voltages may include real even-numbered data voltages and virtual odd-numbered data voltages obtained by converting the odd-numbered row data generated by the calculation mentioned above.

In the progressive mode, the data driver 130 receives the first inversion signal REV1 from the logic circuit 110 and controls the polarity of the data voltages according to the first inversion signal REV1. The first inversion signal REV1 is phase inverted every one frame period and inverted every one pixel row within the one frame period. Therefore, the polarity of the data voltages is inverted every one frame period and inverted every one pixel row within the one frame period in the progressive mode.

In the interlace mode, the data driver 130 receives the second inversion signal REV2 from the logic circuit 110 and controls the polarity of the data voltages in accordance with the second inversion signal REV2. The second inversion signal REV2 is phase inverted every two frame periods and inverted every one pixel row within the one frame period. Therefore, the polarity of the data voltages is inverted every two frame periods and inverted every one pixel row within the one frame period in the interlace mode.

In an exemplary embodiment, the timing controller 120 and the data driver 130 include an interface device that utilizes a low voltage differential signaling (LVDS) scheme. According to the LVDS scheme, the first and second inversion signals REV1 and REV2 may be separately and independently transmitted from the control signals.

Although not shown in figures, the first and second inversion signals REV1 and REV2 may be inverted every two, three, or four rows within the one frame period. For example, if the inversion signal REV1 is inverted every two rows, the polarity is maintained during sequential application of gate voltages to two gate lines, the polarity is inverted, and then the inverted polarity is maintained during sequential application of gate voltages to the next two gate lines.

When the gate signals are sequentially applied to the gate lines G1 to Gn, pixel rows connected to the gate lines G1 to Gn are sequentially turned on. The data voltages are applied to the turned-on pixel rows to control a transmittance of light passing through the liquid crystals. Thus, the display panel 200 may display desired images.

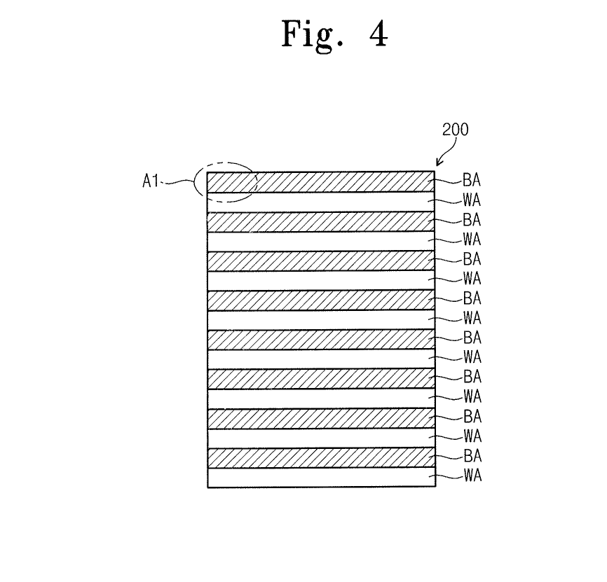

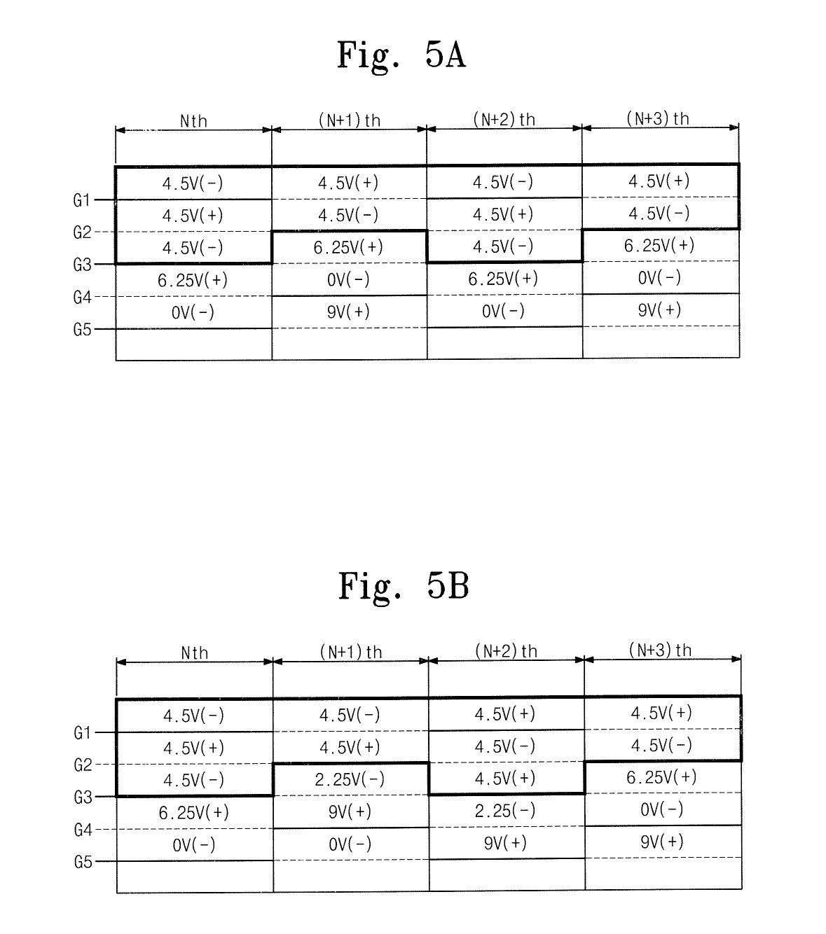

FIG. 4 is a plan view showing a screen of a display panel in which a black pattern and a white pattern are repeatedly displayed, FIG. 5A is a view showing a data voltage of an area A1 of FIG. 4 in an example of a 1-frame inversion driving scheme, and FIG. 5B is a view showing a data voltage of an area A1 of FIG. 4 in an example of a 2-frame inversion driving scheme.

FIG. 4 shows the display panel 200 that displays a striped pattern. In FIG. 4, first areas BA display a black gray scale and second areas WA display a white gray scale. The colors have not been shown in FIG. 4.

When the display panel 200 is operated in the interlace mode, an electric potential occurs between the first area BA and the second area WA.

In FIG. 5A and FIG. 5B, when a reference voltage is about 4.5 volts, the black gray scale is represented by a voltage (hereinafter, referred to as black data voltage) of about 4.5 volts and the white gray scale is represented by a voltage of about 9 volts or 0 volts (hereinafter, referred to as a white data voltage). In FIGS. 5A and 5B, a positive (+) and a negative (−) indicate the polarity of the data voltage with respect to the reference voltage. For example, when the data voltage applied to each pixel row is larger than the reference voltage, the data voltage is represented as the positive (+), and when the data voltage applied to each pixel row is smaller than the reference voltage, the data voltage is represented as the negative (−). For the convenience of explanation, the black data voltage is referred to as 4.5 volts. However, embodiments of the invention are not limited to any particular voltage, as different voltages can be used to represent the reference voltage, the black data voltage, and the white data voltage.

Referring to FIG. 5A, during the first frame period Nth, the pixel rows connected to first, third, and fifth gate lines G1, G3, and G5 receive the real data voltage and the pixel rows connected to second and fourth gate lines G2 and G4 receive the virtual data voltage.

For example, a real data voltage is a data voltage applied to a pixel row (e.g., an odd numbered pixel row) and the virtual data voltage is a data voltage applied to another pixel row (e.g., an even numbered pixel row) that is derived from two of the real data voltages (e.g., an average of the data voltages applied to even numbered pixel rows located before and after an odd numbered pixel row).

Since the pixel rows (hereinafter, referred to as first and third pixel rows) connected to the first and third gate lines G1 and G3 are placed in the first area BA shown in FIG. 4, the first and third pixel rows receive the negative (−) black data voltage of about 4.5 volts, and the pixel row (hereinafter, referred to as fifth pixel row) connected to the fifth gate line G5 receives the negative (−) white data voltage of about 0 volts since the fifth pixel row is placed in the second area WA shown in FIG. 4.

The pixel row (hereinafter, referred to as second pixel row) connected to the second gate line G2 is applied with an average value (e.g., the black data voltage) of the black data voltage applied to the first pixel row and the black data voltage applied to the third pixel row. However, since the polarity of the data voltage is inverted every one pixel row, the second pixel row is applied with the positive (+) black data voltage of about 4.5 volts.

In addition, the pixel row (hereinafter, referred to as fourth pixel row) connected to the fourth gate line G4 is applied with an average value of the black data voltage applied to the third pixel row and the white data voltage applied to the fifth pixel row. However, since the polarity of the data voltage is inverted every one pixel row, the fourth pixel row is applied with the positive (+) data voltage. For example, the fourth pixel row is applied with the positive (+) data voltage of about 6.25 volts.

Then, during the second frame period (N+1)th, the second and fourth pixel rows connected to the second and fourth gate lines G2 and G4 receive the real data voltage and the first, third and fifth pixel rows connected to the first, third, and fifth gate lines G1, G3, and G5 receive the virtual data voltage.

The second pixel row is placed in the first area BA shown in FIG. 4, so that the second pixel row receives the negative (−) black data voltage of about 4.5 volts. The fourth pixel row is placed in the white area WA shown in FIG. 4, and thus the fourth pixel row receives the negative (−) white data voltage of about 0 volts.

The first pixel row receives the positive (+) black data voltage of about 4.5 volts since the first pixel row is placed in the first area BA, and the third pixel row is applied with an average value of the data voltage applied to the second pixel row and the data voltage applied to the fourth pixel row. In the present exemplary embodiment, since the polarity of the data voltage is inverted every one pixel row and the third pixel row receives the positive (+) data voltage, the third pixel row is applied with the positive (+) data voltage of about 6.25 volts. In addition, the fifth pixel row is placed in the second area WA, so the fifth pixel row is applied with the white data voltage of about 9 volts.

In the 1-frame inversion driving scheme, the polarity of the data voltage applied to each pixel row during the first frame Nth is equal to the polarity of the data voltage applied to a corresponding pixel row of the each pixel row during the third frame period (N+2)th, and the polarity of the data voltage applied to each pixel row during the second frame period (N+1)th is equal to the polarity of the data voltage applied to a corresponding pixel row of the each pixel row during the fourth frame period (N+3)th.

Referring to FIG. 5B, in the 2-frame inversion driving scheme, the polarity of the data voltage applied to each pixel row during the first frame period Nth is equal to the polarity of the data voltage applied to a corresponding pixel row of each pixel row during the second frame period (N+1)th, and the polarity of the data voltage applied to each pixel row during the third frame period (N+2)th is equal to the polarity of the data voltage applied to a corresponding pixel row of the each pixel row during the fourth frame period (N+3)th.

For example, during the first and second frame periods Nth and (N+1)th, the first, third, and fifth pixel rows receive the negative (−) data voltage, and the second and fourth pixel row receive the positive (+) data voltage.

In addition, since the first and third pixel rows are placed in the first area BA shown in FIG. 4, the first and third pixel rows receive the negative (−) black data voltage of about 4.5 volts during the first frame period Nth, and the fifth pixel row receives the negative (−) white data voltage of about 0 volts during the first frame period Nth because the fifth pixel row is placed in the second area WA shown in FIG. 4.

The second pixel row receives an average value of the black data voltage applied to the first pixel row and the black data voltage applied to the third pixel row. Since the polarity of the data voltage is inverted every one pixel row, the second pixel row receives the positive (+) black data voltage of about 4.5 volts.

In addition, the fourth pixel row receives an average value of the black data voltage applied to the third pixel row and the white data voltage applied to the fifth pixel row. Since the polarity of the data voltage is inverted every one pixel row, the fourth pixel row receives the positive (+) data voltage of about 6.25 volts.

Then, the second pixel row is placed in the first area BA shown in FIG. 4, so that the second pixel row receives the positive (+) black data voltage of about 4.5 volts during the second frame period (N+1)th, and the fourth pixel row receives the positive (+) white data voltage of about 9 volts during the second frame period (N+1)th since the fourth pixel row is placed in the second area WA shown in FIG. 4.

Since the first pixel row is placed in the first area BA, the first pixel row receives the negative (−) black data voltage of about 4.5 volts, and the third pixel row is applied with an average value of the data voltage applied to the second pixel row and the data voltage applied to the fourth pixel row. Since the polarity of the data voltage is inverted every one pixel row, the third pixel row is applied with the negative (−) data voltage of about 2.25 volts. In addition, the fifth pixel row is placed in the second area WA, and thus the fifth pixel row receives the negative (−) white data voltage of about 0 volts.

Since the first and third pixel rows are placed in the first area BA shown in FIG. 4, the first and third pixel rows receive the positive (+) black data voltage of about 4.5 volts during the third frame period (N+2)th, and the fifth pixel row receives the positive (+) white data voltage of about 9 volts during the third frame period (N+2)th because the fifth pixel row is placed in the second area WA shown in FIG. 4.

The second pixel row is applied with an average value of the black data voltage applied to the first pixel row and the black data voltage applied to the third pixel row. Since the polarity of the data voltage is inverted every one pixel row, the second pixel row is applied with the negative (−) black data voltage of about 4.5 volts.

In addition, the fourth pixel row receives an average value of the black data voltage applied to the third pixel row and the white data voltage applied to the fifth pixel row. Since the polarity of the data voltage is inverted every one pixel row, the fourth pixel row receives the negative (−) data voltage of about 2.25 volts.

Then, the second pixel row is placed in the first area BA shown in FIG. 4, so that the second pixel row receives the negative (−) black data voltage of about 4.5 volts during the fourth frame period (N+3)th, and the fourth pixel row receives the negative (−) white data voltage of about 0 volts during the fourth frame period (N+3)th since the fourth pixel row is placed in the second area WA shown in FIG. 4.

Since the first pixel row is placed in the first area BA, the first pixel row receives the positive (+) black data voltage of about 4.5 volts, and the third pixel row is applied with an average value of the data voltage applied to the second pixel row and the data voltage applied to the fourth pixel row. Since the polarity of the data voltage is inverted every one pixel row, the third pixel row is applied with the positive (+) data voltage of about 6.25 volts. In addition, the fifth pixel row is placed in the second area WA, and thus the fifth pixel row receives the positive (+) white data voltage of about 9 volts.

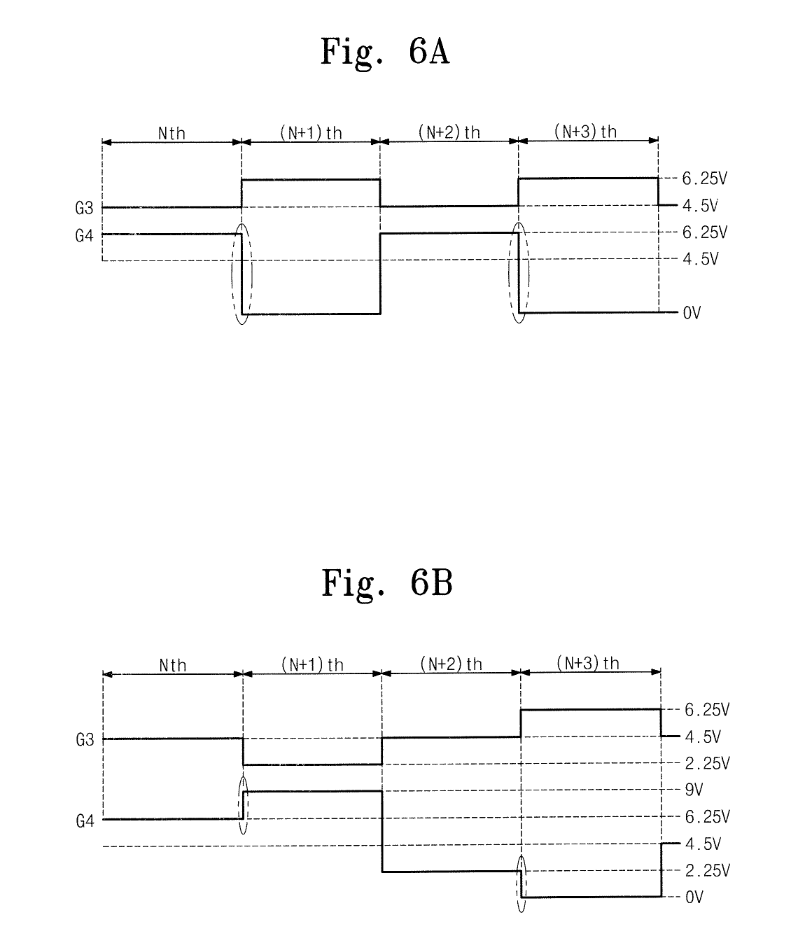

FIG. 6A is a waveform diagram showing a variation of a data voltage shown in FIG. 5A and FIG. 6B is a waveform diagram showing a variation of a data voltage shown in FIG. 5B.

In particular, FIG. 6A shows the data voltages applied to the third and fourth pixel rows disposed between the first and second areas BA and WA of the display panel 200 when the display panel 200 is operated in the 1-frame inversion driving scheme.

In the 1-frame inversion driving scheme, the data voltage applied to the fourth pixel row is about 6.25 volts in the first frame period Nth and about 0 volts in the second frame period (N+1)th. For example, the electric potential difference between the first and second frames Nth and (N+1)th is about 6.25 volts. In addition, the electric potential difference between the second frame (N+1)th and the third frame (N+2)th and between the third frame (N+2)th and the fourth frame (N+3)th is about 6.25 volts.

FIG. 6B shows the data voltages applied to the third and fourth pixel rows disposed between the first and second areas BA and WA of the display panel 200 when the display panel 200 is operated in the 2-frame inversion driving scheme.

In the 2-frame inversion driving scheme, the data voltage applied to the fourth pixel row is about 6.25 volts in the first frame period Nth and about 9 volts in the second frame period (N+1)th. Consequently, the electric potential difference between the first and second frames Nth and (N+1)th is about 2.25 volts. In addition, the electric potential difference between the third frame (N+2)th and the fourth frame (N+3)th is about 2.25 volts.

However, embodiments of the invention are not limited to particular electric potential differences and may vary when different voltages are applied to the pixel rows.

When the polarity of the data voltage is inverted every two frame periods in the interlace mode, the electric potential difference between two frames may be reduced, which may occur between two areas (e.g., the first and second areas BA and WA) where a gray scale difference is present.

Due to the electric potential difference between two frames, which may occur between two areas where a gray scale difference is present, flickering may occur on the display panel 200. Accordingly, when the electric potential difference is reduced, the flickering may be prevented.

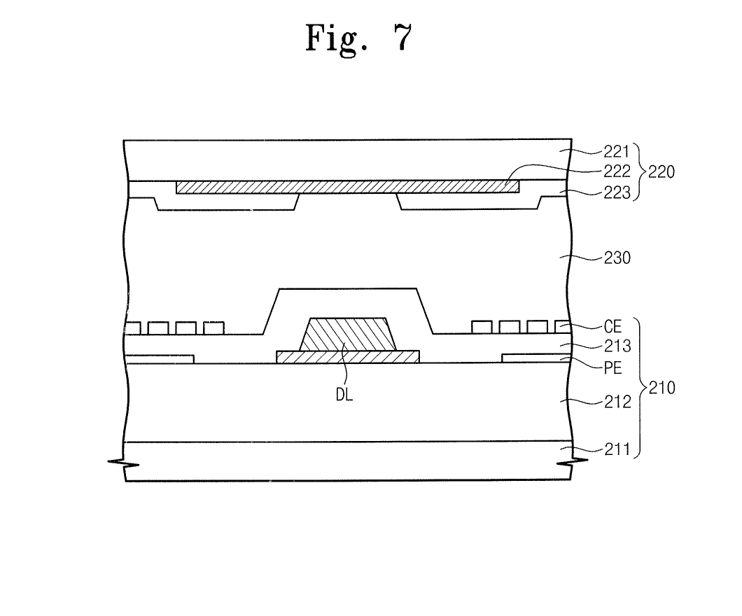

FIG. 7 is a cross-sectional view showing a display apparatus according to an exemplary embodiment of the invention. As an example, the display panel may be, but is not limited to, a plane-to-line switching (PLS) mode liquid crystal display panel. The PLS mode liquid crystal display panel drives the liquid crystal layer using a horizontal electric field and a vertical electric field to display an image.

Referring to FIG. 7, the display panel 200 includes a first substrate 210 on which a pixel PX is disposed, a second substrate 220 facing the first substrate 210, and a liquid crystal layer 230 interposed between the first substrate 210 and the second substrate 230.

The first substrate 210 includes a first base substrate 211, and the pixel PX, a gate line (not shown), and a data line DL disposed on the first base substrate 211. FIG. 7 shows a cross-sectional structure of a portion of the pixel.

As shown in FIG. 7, a gate insulating layer 212 is formed on the first base substrate 211 to cover the gate line. The data line DL is disposed on the gate insulating layer 212. In addition, a pixel electrode PE is formed adjacent the data line DL. As an example, the data line DL may have a double-layer structure of two metal layers stacked one on another. In addition, the pixel electrode PE may include a transparent conductive material, such as indium tin oxide. Although not shown in figures, the pixel electrode PE is connected to a thin film transistor Tr of the pixel PX to receive the data voltage.

The pixel electrode PE and the data line DL is covered by a protective layer 213. The protective layer 213 may include silicon nitride SiNx.

The common electrode CE is formed on the protective layer 213. The common electrode CE receives the reference voltage. An electric field is formed between the common electrode CE and the pixel electrode PE by the electric potential difference between the data voltage and the reference voltage.

Since the protective layer 213 is a solid different from that of the liquid crystal layer 230, electrons are trapped in the protective layer 213 when the electric potential difference occurs between two consecutive frames. Due to the trap effect of the electrons, a flickering may appear on the display panel 200 when the display panel 200 displays the image.

When the mode is switched to the progressive mode from the interlace mode, a linear after-image may appear at a boundary between the first and second areas BA and WA (refer to FIG. 4).

As shown in FIGS. 5A, 5B, 6A, and 6B, however, when the polarity of the data voltage is inverted every two or more frame periods, the electric potential difference between two consecutive frames may be reduced. Accordingly, flickering may be reduced, thereby preventing the after-image from occurring when the mode is switched.

The second substrate 220 includes a second base substrate 221, a black matrix 222 disposed on the second base substrate 221, and a color filter layer 223 disposed on the second base substrate 221. The color filter layer 223 includes red, green, and blue color filters.

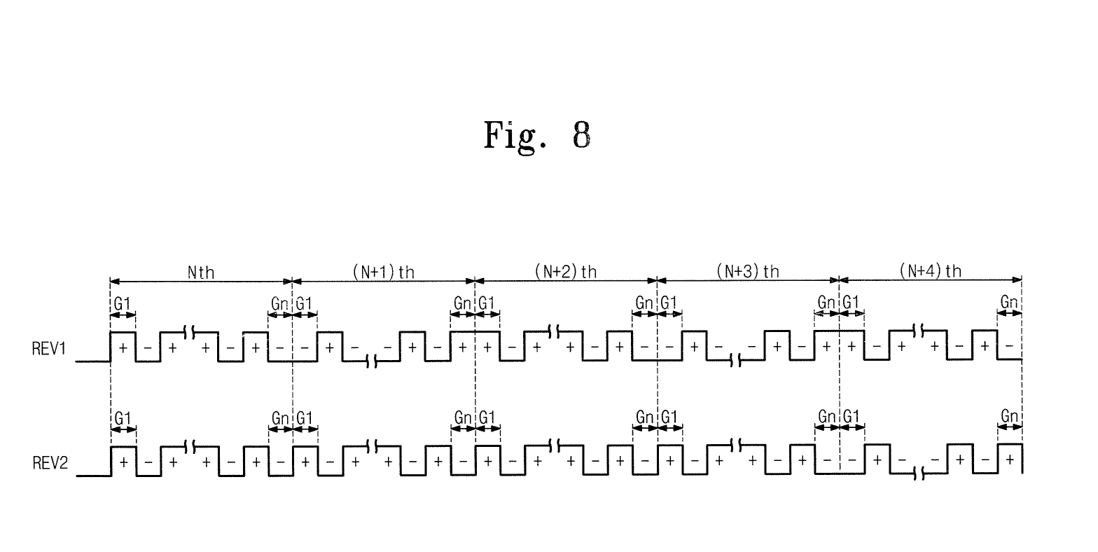

FIG. 8 is a waveform diagram showing first and second inversion signals according to an exemplary embodiment of the present invention.

Referring to FIG. 8, the first inversion signal REV1 is phase inverted every frame period and inverted every one row (e.g., one gate line) within one frame period. As an example, the second inversion signal REV2 is phase inverted every four frame periods and inverted every one row within the one frame period. The second inversion signal REV2 may be inverted every 2n frame periods (e.g., n is a natural number equal to or larger than 1), even though the second inversion signal REV2 being inverted every four frame periods is shown in FIG. 8 as an example.

When the polarity of the data voltage is inverted every four or more frame periods, the electric potential difference between four consecutive frames, in which the polarity of the data voltage is unchanged, may be reduced. Thus, the flickering may be reduced, which may prevent the after-image from occurring when the mode is switched.

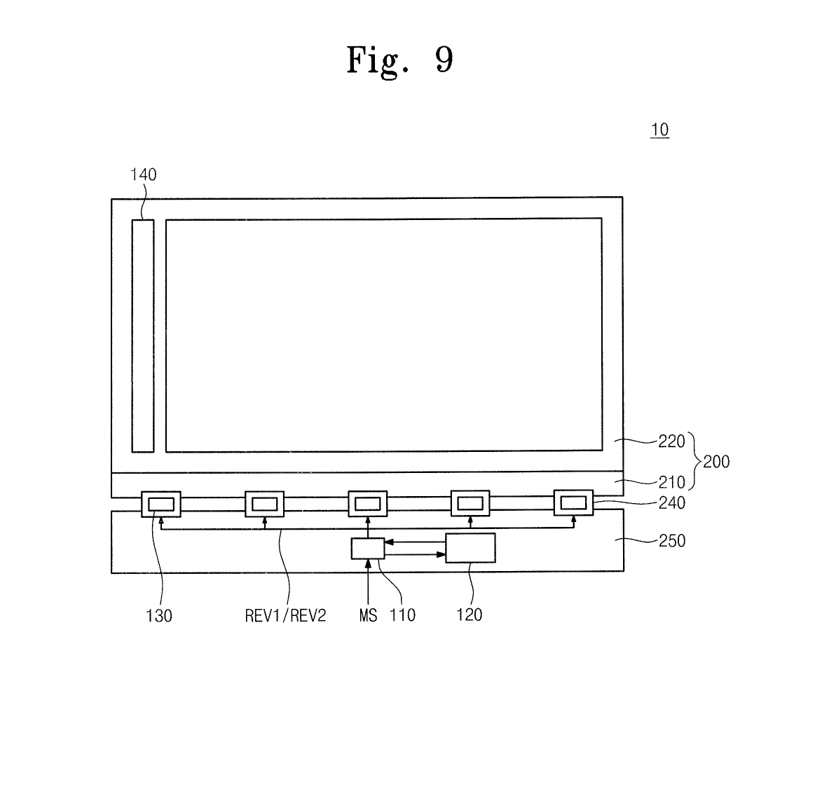

FIG. 9 is a plan view showing the display apparatus shown in FIG. 1.

Referring to FIG. 9, the display apparatus 10 may further include a plurality of tape carrier packages 240 (TCP) attached to a side of the display panel 200 and a printed circuit board 250.

In an exemplary embodiment, the data driver 130 is provided on the display apparatus 10 in a plurality of driving chips 130. However, the inventive concept is not limited thereto. The driving chips 130 are mounted on the TCP 240, respectively.

The logic circuit 110 and the timing controller 120 may be provided on the printed circuit board 250 in the form of a chip. The logic circuit 110 is connected to the driving chips 130 and applies the first inversion signal REV1 or the second inversion signal REV2 to the driving chips 130 in response to the mode selection signal MS. For example, the logic circuit 110 applies the first inversion signal REV1 if the mode selection signal MS indicates a progressive mode and applies the second inversion signal REV2 if the mode selection signal MS indicates an interlace mode.

The gate driver 140 may be directly formed on the first substrate 210 of the display panel 200 through a thin film process. The gate driver 140 may be covered by the second substrate 220 and provided in a black matrix area of the display panel 200.

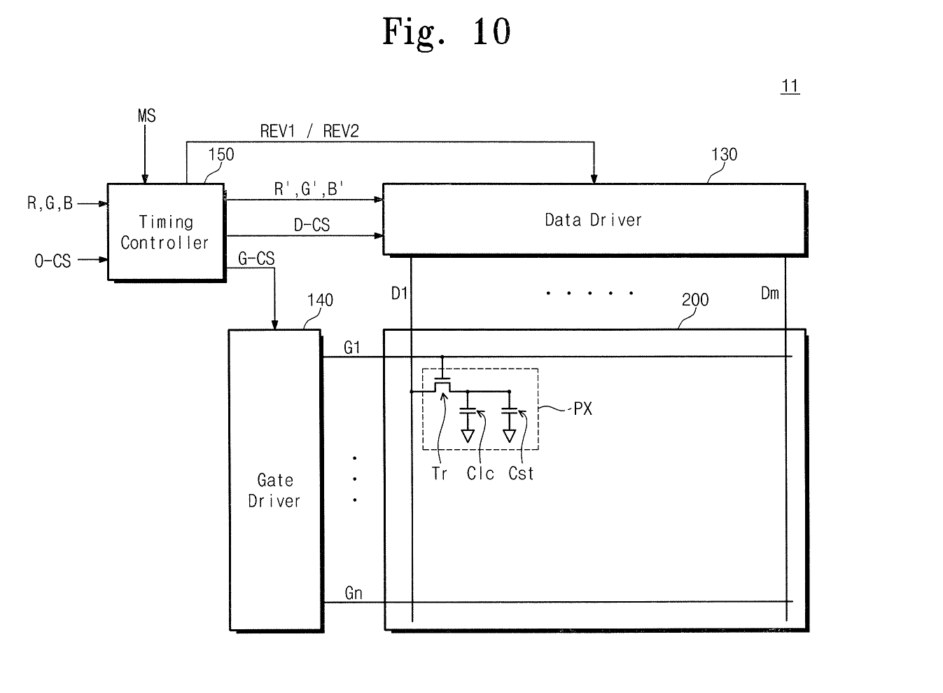

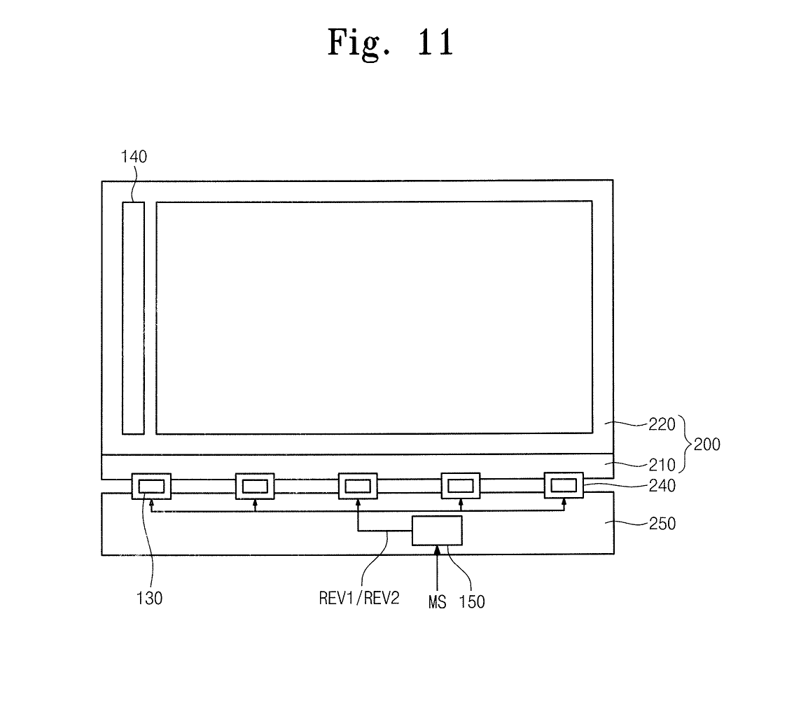

FIG. 10 is a block diagram showing a display apparatus according an exemplary embodiment of the invention and FIG. 11 is a plan view showing the display apparatus shown in FIG. 10. In FIGS. 10 and 11, the same reference numerals denote the same elements in FIGS. 1 to 9, and thus detailed descriptions of the same elements will be omitted.

Referring to FIG. 10, a display apparatus 11 includes a timing controller 150, a data driver 130, a gate driver 140, and a display panel 200.

The timing controller 150 may include an additional pin to which the mode selection signal MS is applied. For example, the timing controller 150 may include the pin for receiving the mode selection signal MS in addition to a pin for receiving the image signals R, G, B, a pin for receiving the control signals O-CS, a pin for outputting the selected inversions signal REV1 or REV2, a pin for outputting the converted image signals R′, G′, B′, a pin for outputting the data control signal D-CS, and a pin for outputting the gate control signal G-CS. Accordingly, the timing controller 150 outputs the first inversion signal REV1 or the second inversion signal REV2 in accordance with the logic high or low state of the mode selection signal MS.

For instance, the mode selection signal MS is generated in the logic low state when the display panel 200 is operated in the progressive mode, and the mode selection signal MS is generated in the logic high state when the display panel 200 is operated in the interlace mode. The timing controller 150 applies the first inversion signal REV1 to the data driver 130 when the mode selection signal MS is the logic low state, and the timing controller 150 applies the second inversion signal REV2 to the data driver 130 when the mode selection signal MS is the logic high state.

As described in an embodiment above, the first inversion signal REV1 is phase inverted every frame period and inverted every row within the one frame period. In addition, the phase of the second inversion signal REV2 is inverted every 2n frame period and inverted every row within the one frame period in this embodiment.

As shown in FIG. 11, a plurality of TCPs 240 and a printed circuit board 250 are disposed on a side of the display panel 200. The data driver 130 is provided in the form of a chip to be mounted on the TCPs 240, and the timing controller 150 is provided in the form of a chip and mounted on the printed circuit board 250.

The timing controller 150 includes an additional pin and applies the first inversion signal REV1 or the second inversion signal REV2 to the driving chips 130 in response to the mode selection signal MS. The additional pin may be used to receive the mode selection signal MS.

When the mode of the display panel 200 is switched to the progressive mode from the interlace mode, a linear after-image may appear at a boundary between the first and second areas BA and WA (refer to FIG. 4).

As shown in FIGS. 5A, 5B, 6A, and 6B, however, when the polarity of the data voltage is inverted every two or more frame periods, the electric potential difference between two consecutive frames may be reduced. Accordingly, flickering may be reduced, and an after-image may be prevented from occurring when the mode is switched.

Although exemplary embodiments of the present invention have been described, it is to be understood that the present invention is not limited to these exemplary embodiments as various changes and modifications can be made that are within the spirit and scope of the present invention.

What is claimed is:

1. A display apparatus comprising:
a signal controller configured to receive an image signal in accordance with a data transmission mode, receive a mode selection signal indicating the data transmission mode, and output one of a first inversion signal and a second inversion signal based on the indicated mode;
a data driver configured to convert the image signal from the signal controller to data signals and control a polarity of the data signals based on the inversion signal output from the signal controller;
a display part comprising a plurality of pixels configured to display an image; and
a gate driver,
wherein the signal controller is further configured to control the gate driver to sequentially output a plurality of gate signals to operate the pixels to receive the data signals.

2. The display apparatus of claim 1, wherein the data transmission mode comprises a progressive mode and an interlace mode, the signal controller is configured to receive data corresponding to one frame in the progressive mode, and the signal controller is configured to receive odd-numbered row data corresponding to odd-numbered pixel rows of the pixels during a first frame period in the interlace mode and receive even-numbered row data corresponding to even-numbered pixel rows of the pixels during a second frame period in the interlace mode.

3. The display apparatus of claim 2, wherein the signal controller is configured to output the first inversion signal in the progressive mode and output the second inversion signal in the interlace mode.

4. The display apparatus of claim 3, wherein the first inversion signal is phase inverted every frame period and the second inversion signal is phase inverted every 2n frame periods, wherein n is a natural number equal to or larger than 1.

5. The display apparatus of claim 4, wherein each of the first and second inversion signals is polarity inverted every one row in one frame period.

6. The display apparatus of claim 2, wherein, in the interlace mode, the signal controller is configured to generate an (i+1)th row data based on an i-th row data and an (i+2)th row data to generate first frame data corresponding to the one frame during the first frame period and to generate a (j+1)th row data based on a j-th row data and an (j+2)th row data to generate second frame data corresponding to the one frame during the second frame period, wherein ‘i’ is an odd number equal to or larger than 1 and ‘j’ is an even number equal to or larger than 2.

7. The display apparatus of claim 1, wherein the signal controller comprises:
a logic circuit that is configured to receive the mode selection signal to output one of the first and second inversion signals; and
a timing controller that is configured to receive the image signal in accordance with the data transmission mode to control an output timing of the first inversion signal or the second inversion signal from the logic circuit.

8. The display apparatus of claim 1, wherein the signal controller comprises a timing controller, and the timing controller comprises an additional pin to which the mode selection signal is applied, wherein the signal controller is configured to control an output timing of the first inversion signal or the second inversion signal, receive the data signals in accordance with the data transmission mode, and control the data driver and the gate driver.

9. The display apparatus of claim 1, wherein the display part comprises:
a first substrate including the pixels;
a second substrate facing the first substrate; and
a liquid crystal layer interposed between the first substrate and the second substrate, wherein each of the pixels comprises:
a first electrode that receives a reference signal;
a protective layer that covers the first electrode; and
a second electrode disposed on the protective layer, the second electrode configured to receive a corresponding one of the data signals.

10. The display apparatus of claim 9, wherein the one data signal has a positive or negative polarity with respect to the reference signal.

11. A method of driving a display apparatus, comprising:
receiving an image signal in accordance with a data transmission mode;
receiving a mode selection signal indicating the data transmission mode to selectively output one of a first inversion signal and a second inversion signal based on the indicated data transmission mode;
converting the image signal to data signals;
receiving the output inversion signal to control a polarity of the data signals;
outputting a plurality of gate signals; and
sequentially operating rows of pixels of the display apparatus in response to the gate signals to display an image corresponding to the data signals.

12. The method of claim 11, wherein the data transmission mode comprises a progressive mode and an interlace mode, the receiving of the mode selection signal and the outputting of the first and second inversion signals are performed by a signal controller, the signal controller receives data corresponding to one frame in the progressive mode, and the signal controller receives odd-numbered row data corresponding to odd-numbered pixel rows during a first frame period in the interlace mode and receives even-numbered row data corresponding to even-numbered pixel row data during a second frame period in the interlace mode.

13. The method of claim 12, wherein the signal controller outputs the first inversion signal in the progressive mode and outputs the second inversion signal in the interlace mode.

14. The method of claim 13, wherein the first inversion signal is phase inverted every frame period and the second inversion signal is phase inverted every 2n frame periods, wherein n is a natural number equal to or larger than 1.

15. The method of claim 14, wherein each of the first and second inversion signals is polarity inverted every one row in one frame period.

16. The method of claim 12, further comprising, in the interlace mode, generating (i+1)th row data based on i-th row data and (i+2)th row data to generate first frame data corresponding to the one frame during the first frame period, and generating (j+1)th row data based on j-th row data and (j+2)th row data to generate second frame data corresponding to the one frame during the second frame period, wherein ‘i’ is an odd number equal to or larger than 1 and ‘j’ is an even number equal to or larger than 2.

17. A display apparatus comprising:
a signal controller configured to receive an image signal and mode selection signal indicating a transmission mode, output a first inversion signal when the mode is progressive and a second inversion signal when the mode is interlace;
a data driver configured to generate data signals from the image signal and control a polarity of the data signals based on the output inversion signal;
a gate driver configured to generate gate signals; and
a display configured to receive the data signals and the gate signals to display an image,
wherein the first inversion signal is inverted each time one of the gate signals is applied during a given image frame period, and
wherein the second inversion signal is inverted each time 2n of the gate signals is applied during the given image period, where n is greater than or equal to 1.

18. The display apparatus of claim 17, wherein the image signal is an entire image frame of the display when the type is progressive, and is even or odd rows of the entire image frame when the type is interlace.

19. The display apparatus of claim 18, wherein even pixel data of one of the even rows is an average of odd pixel data of one of the odd rows prior to the one even row and odd pixel data of one of the odd rows after the one even row.

20. The display apparatus of claim 18, wherein odd pixel data of one of the odd rows is an average of even pixel data of one of the even rows prior to the one odd row and even pixel data of one of the even rows after the one odd row.
